(19) United States
(12) Patent Application Publication
(10) Pub. No.: US 2024/0370794 A1
(43) Pub. Date: Nov. 7, 2024

(54) INFORMATION PROCESSING APPARATUS, INFORMATION PROCESSING METHOD, AND INFORMATION PROCESSING PROGRAM

(71) Applicant: FUJIFILM Corporation, Tokyo (JP)

(72) Inventors: Takuya OSUGI, Kanagawa (JP); Hiroshi YONEKUBO, Kanagawa (JP); Masashi SATO, Kanagawa (JP)

(73) Assignee: FUJIFILM Corporation, Tokyo (JP)

(21) Appl. No.: 18/771,897

(22) Filed: Jul. 12, 2024

Related U.S. Application Data
(63) Continuation of application No. PCT/JP2022/036936, filed on Oct. 3, 2022.

(30) Foreign Application Priority Data
Jan. 14, 2022 (JP) 2022-004644

(51) Int. Cl. G06Q 10/0631

(52) U.S. Cl. CPC G06Q 10/063116; G06Q 10/063112

(57) ABSTRACT

An information processing apparatus executes a first process of generating a work shift table in which a constraint condition regarding a work shift of an employee is satisfied, and an output value of an objective function regarding a desire of the employee for the work shift is minimized, the constraint condition being based on a possession skill assigned to each of a plurality of the employees and representing an ability to implement work on a work target, and the number of employees required in a predetermined period, and outputs whether or not a feasible solution exists in the first process.

### CROSS-REFERENCE TO RELATED APPLICATIONS

This application is a continuation application of International Application No. PCT/JP2022/036936, filed on Oct. 3, 2022, which is incorporated herein by reference in its entirety. Further, this application claims priority from Japanese Patent Application No. 2022-004644, filed on Jan. 14, 2022, the disclosure of which is incorporated by reference herein in its entirety.

### BACKGROUND

### Technical Field

The present disclosure relates to an information processing apparatus, an information processing method, and an information processing program.

### Related Art

JP2021-120791A discloses a technique of generating a work shift table based on work desire information including a desired work date and a desired work time slot of a worker and role information representing a role of the worker.

However, in the technique disclosed in JP2021-120791A, the work shift table is generated based on a relatively rough classification such as the role of the worker, so that it may be difficult to generate a detailed work shift table.

### SUMMARY

The present disclosure has been made in view of the above circumstances, and an object of the present disclosure is to provide an information processing apparatus, an information processing method, and an information processing program capable of generating a detailed work shift table.

According to the present disclosure, there is provided an information processing apparatus comprising: at least one processor, in which the processor executes a first process of generating a work shift table in which a constraint condition regarding a work shift of an employee is satisfied, and an output value of an objective function regarding a desire of the employee for the work shift is minimized, the constraint condition being based on a possession skill assigned to each of a plurality of the employees and representing an ability to implement work on a work target, and the number of employees required in a predetermined period, and outputs whether or not a feasible solution exists in the first process.

In the information processing apparatus according to the present disclosure, in a case where the feasible solution does not exist in the first process, the processor may output cause information representing a cause of absence of the feasible solution. As a result, it is possible for a user to understand a cause of the inability to obtain the feasible solution.

In addition, in the information processing apparatus according to the present disclosure, the plurality of employees may be employees belonging to a first organization, and the processor may execute a second process of generating a work shift table in which an output value of an objective function regarding the number of employees to be replenished from a second organization different from the first organization is minimized in a case where the feasible solution does not exist in the first process, and output an insufficient number of employees of the first organization in the period for each possession skill, as the cause information. As a result, it is possible for the user to understand details of the cause of the inability to obtain the feasible solution.

In addition, in the information processing apparatus according to the present disclosure, in the second process, the processor may further generate a work shift table in which an output value of an objective function regarding the insufficient number of employees in the period is minimized. As a result, it is possible to generate an appropriate work shift table.

In addition, in the information processing apparatus according to the present disclosure, in a case where the feasible solution does not exist in the second process, the processor may generate the work shift table after relaxing the constraint condition. As a result, it is possible to generate an appropriate work shift table.

In addition, in the information processing apparatus according to the present disclosure, in a case where the insufficient number of employees is one or more, the processor may generate the work shift table after relaxing the constraint condition. As a result, it is possible to generate an appropriate work shift table.

In addition, in the information processing apparatus according to the present disclosure, the possession skill may be assigned to the employee for each of a plurality of the work targets. As a result, it is possible to generate a detailed work shift table.

In addition, in the information processing apparatus according to the present disclosure, the number of employees required in the period may be set for each position of the employee. As a result, it is possible to generate a detailed work shift table.

In addition, in the information processing apparatus according to the present disclosure, the desire of the employee for the work shift may be represented by a degree of possibility of attendance of the employee in the period. As a result, it is possible to generate an appropriate work shift table.

In addition, according to the present disclosure, there is provided an information processing method executed by a processor of an information processing apparatus, the method comprising: executing a first process of generating a work shift table in which a constraint condition regarding a work shift of an employee is satisfied, and an output value of an objective function regarding a desire of the employee for the work shift is minimized, the constraint condition being based on a possession skill assigned to each of a plurality of the employees and representing an ability to implement work on a work target, and the number of employees required in a predetermined period; and outputting whether or not a feasible solution exists in the first process.

In addition, according to the present disclosure, there is provided an information processing program for causing a processor of an information processing apparatus to execute: executing a first process of generating a work shift table in which a constraint condition regarding a work shift of an employee is satisfied, and an output value of an objective function regarding a desire of the employee for the work shift is minimized, the constraint condition being based on a possession skill assigned to each of a plurality of the employees and representing an ability to implement work on a work target, and the number of employees required in a predetermined period; and outputting whether or not a feasible solution exists in the first process.

According to the present disclosure, it is possible to generate a detailed work shift table.

### BRIEF DESCRIPTION OF THE DRAWINGS

FIG. 1 is a block diagram showing an example of a hardware configuration of an information processing apparatus.

FIG. 2 is a schematic diagram showing an example of data on a person in charge of a first organization.

FIG. 3 is a schematic diagram showing an example of common work data of the first organization.

FIG. 4 is a schematic diagram showing an example of individual work data of the first organization.

FIG. 5 is a schematic diagram showing an example of data on the number of employees required for each first period.

FIG. 6 is a schematic diagram showing an example of data on the number of employees who can implement common work required for each first period.

FIG. 7 is a schematic diagram showing an example of data on the number of employees who can implement individual work required for each first period.

FIG. 8 is a schematic diagram showing an example of work desire data of employees of the first organization.

FIG. 9 is a schematic diagram showing an example of data on a person in charge of a second organization.

FIG. 10 is a schematic diagram showing an example of common work data of the second organization.

FIG. 11 is a schematic diagram showing an example of individual work data of the second organization.

FIG. 12 is a schematic diagram showing an example of replenishment possibility data of a replenishment member.

FIG. 13 is a block diagram showing an example of a functional configuration of the information processing apparatus.

FIG. 14 is a diagram showing an example of a work shift table obtained by a first process.

FIG. 15 is a diagram showing an example of a display screen in a case where there is no feasible solution in the first process.

FIG. 16 is a diagram showing an example of a work shift table obtained by a second process.

FIG. 17 is a flowchart showing an example of work shift table generation processing.

FIG. 18 is a diagram showing an example of a display screen in a case where there is no feasible solution in a second process according to a modification example.

### DETAILED DESCRIPTION

Hereinafter, examples of an embodiment for implementing the technique of the present disclosure will be described in detail with reference to the drawings.

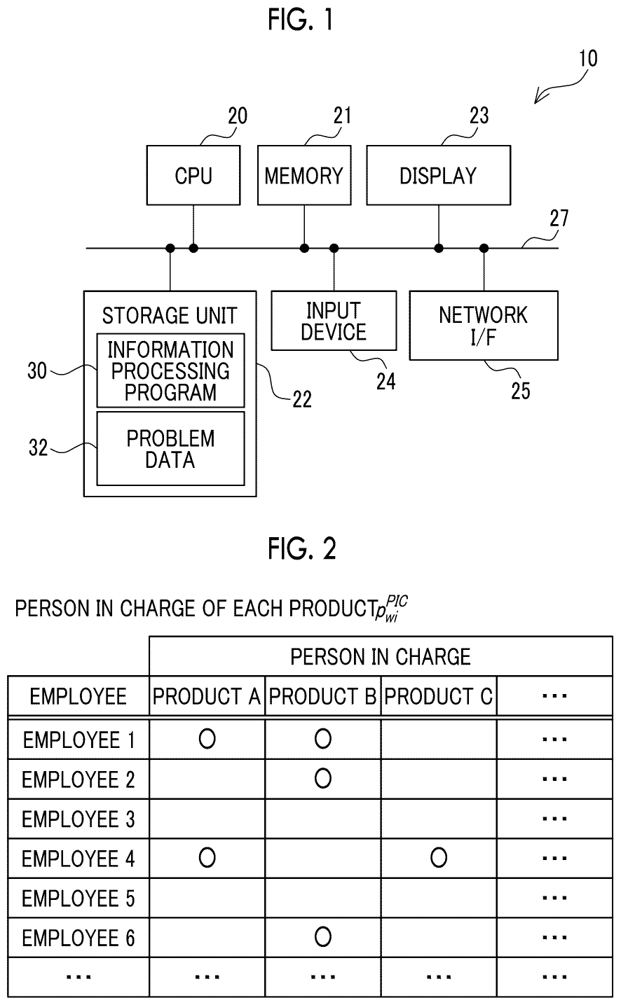

First, with reference to FIG. 1, a hardware configuration of an information processing apparatus 10 according to the present embodiment will be described. Examples of the information processing apparatus 10 include a computer such as a personal computer or a server computer. As shown in FIG. 1, the information processing apparatus 10 includes a central processing unit (CPU) 20, a memory 21 as a transitory storage region, and a non-volatile storage unit 22. In addition, the information processing apparatus 10 includes a display 23 such as a liquid crystal display, an input device 24 such as a keyboard and a mouse, and a network interface (I/F) 25 connected to a network. The CPU 20, the memory 21, the storage unit 22, the display 23, the input device 24, and the network I/F 25 are connected to a bus 27. The CPU 20 is an example of a processor.

The storage unit 22 is realized by a hard disk drive (HDD), a solid state drive (SSD), a flash memory, or the like. An information processing program 30 is stored in the storage unit 22 as a storage medium. The CPU 20 reads out the information processing program 30 from the storage unit 22, loads the readout information processing program 30 in the memory 21, and executes the loaded information processing program 30.

In addition, the storage unit 22 stores problem data 32 in which an optimization problem that is a target of solution processing by the information processing apparatus 10 is set as a data format that can be solved by the information processing apparatus 10.

Next, an example of the problem data 32 according to the present embodiment will be described with reference to FIGS. 2 to 12. In the present embodiment, as an example of the optimization problem, a case will be described in which a problem of creating a work shift table (hereinafter, referred to as a “shift creation problem”) is applied in an organization of a work form of a shift system. In the present embodiment, an example will be described in which each employee presents a desire for a work shift in a second period (one week in the present embodiment) longer than a first period (one day in the present embodiment) in a unit of the first period, and the information processing apparatus 10 generates the work shift table based on the desire of each employee. That is, the work shift table according to the present embodiment includes data representing whether or not each employee goes to work or takes a day off on each day of one week.

In addition, in the present embodiment, a case will be described in which a plurality of kinds of products are applied as a work target and a plurality of kinds of work related to cell culture are applied as the work performed on the plurality of kinds of products. That is, the product according to the present embodiment is obtained as a result of the cell culture. In addition, in the present embodiment, an example will be described in which a manufacturing department is applied as a first organization that mainly performs work on the product, and a production management department is applied as a second organization that performs work on the product as an auxiliary. That is, the second organization is an organization different from the first organization. In the present embodiment, in a case where the number of persons is not enough only with employees of the first organization, the number of persons is replenished with employees of the second organization. Hereinafter, the employee of the second organization is also referred to as a “replenishment member”.

The problem data 32 according to the present embodiment includes data represented by the following symbols. The problem data 32 is, for example, created in advance by the user, and is uploaded to the information processing apparatus 10.
W: set of employees of manufacturing department
D={1, 2, . . . }: set of dates for which work shift table is created (integer in ascending order from 1 is given as ID)
I: set of products
S^{common}: set of works common to all products
Sᵢ^{product}: set of individual works required for manufacturing product
p_{wi}^{PIC}∈{0,1}, w∈W, i∈I: whether employee w is person in charge of product i (0: not applicable, 1: applicable)
p_{ws}^{common} ∈{0,1}, w∈W, s∈S^{common}: whether employee w possesses skill to implement work s common to all products (0: not possess, 1: possess)
p_{ws}^{product}∈{0,1}, w∈W, i∈I, s∈S: whether employee w possesses skill to implement work s of product i (0: not possess, 1: possess)
a_{d}, d∈D: the number of required employees on date d
a^{PIC}=1: the number of persons in charge required for each day and each product (one or now persons in charge are required for each day and each product)
a_{ds}^{common}, d∈D, s∈S^{common}: the number of employees who possess skill for work s common to all products required on date d
a_{ds}^{product}, d∈D, i∈I, s∈Sᵢ^{product}: the number of employees who possess skill for work s of product i required on date d
C: the number or holidays required for each employee within designated period
e: upper limit of the number of consecutive days of attendance of each employee
q_{wd}, w∈W, d∈D: desire of employee w for wok shift on dated
   the following three values can be taken
   q_{wd}=1: desire to go to work
   q_{wd}=−1: desire to take day off
   q_{wd}=10: desire to definitely take day off
H: set of replenishment members
rₕᵢ^{PIC}∈{0,1}, h∈H, i∈I: whether replenishment member h is person in charge of product i (0: not applicable, 1: applicable)
rₕₛ^{common}∈{0,1}, h∈H, s∈S^{common}: whether replenishment member h possesses skill to implement work s common to all products (0: not possess, 1: possess)
rₕₛ^{product}∈{0,1}, h∈H, i∈I, s∈Sᵢ^{product}: whether replenishment member h possesses skill to implement work s of product i (0: not possess, 1: possess)
t_{hd}∈{0,1}, h∈H, d∈D: replenishment possibility of replacement member on date d (0: replenishment impossible, 1: replenishment possible)

Specifically, as shown in FIG. 2, the problem data 32 includes data representing whether the employee of the first organization is a person in charge of each product. In the example of FIG. 2, for the employees of the first organization, a position of a person in charge is assigned for a product of a column described with a circle mark, and a position of a person not in charge is assigned for a product of a blank column. The example of FIG. 2 represents that an employee 1 is a person in charge of a product A and a product B and is a person not in charge of a product C.

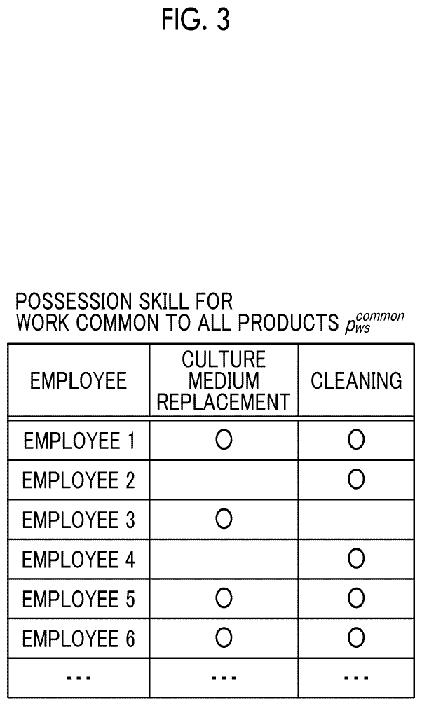

In addition, as shown in FIG. 3, the problem data 32 includes data representing a possession skill indicating that the employee of the first organization can implement works common to all the products (hereinafter, referred to as “common work”). In the example of FIG. 3, each employee of the first organization can implement the common work of a column described with a circle mark, and cannot implement the common work of a blank column. That is, the possession skill for the common work is assigned to each of a plurality of the employees of the first organization. The example of FIG. 3 represents that the employee 1 can implement each work of culture medium replacement and cleaning on all the products.

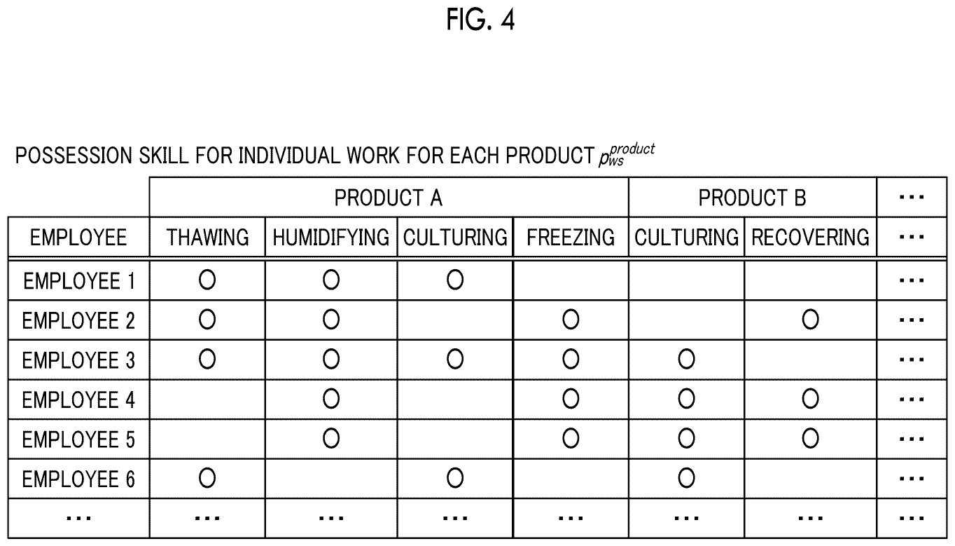

In addition, as shown in FIG. 4, the problem data 32 includes data representing a possession skill indicating that the employee of the first organization can individually implement work for each product (hereinafter, referred to as “individual work”). In the example of FIG. 4, each employee of the first organization can implement the individual work of a column described with a circle mark, and cannot implement the individual work of a blank column. That is, the possession skill for the individual work is assigned to each of the plurality of employees of the first organization for each of a plurality of the products. The example of FIG. 4 represents that the employee 1 can implement each work of thawing, humidifying, and culturing on the product A, and cannot implement freezing work. In addition, the example of FIG. 4 represents that the employee 1 cannot implement each work of culturing and recovering on the product B. Hereinafter, an employee who can implement the work on the product, that is, an employee who is assigned a possession skill for the work on the product is also referred to as an employee who possesses a skill for the work on the product.

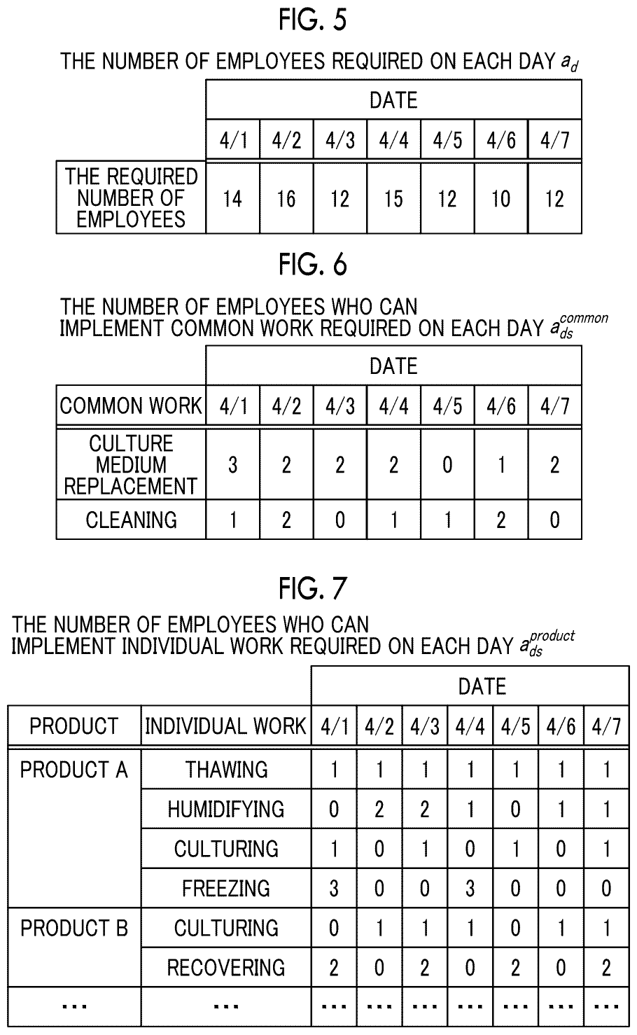

In addition, as shown in FIG. 5, the problem data 32 includes data representing the number of employees required in each first period (one day in the present embodiment) within the second period (one week in the present embodiment). The example of FIG. 5 represents that a total of 14 employees are required in total on April 1.

In addition, as shown in FIG. 6, the problem data 32 includes data representing the number of employees who can implement the common work required in each first period within the second period. The example of FIG. 6 represents that, on April 1, three employees who can implement the culture medium replacement work are required and one employee who can implement the cleaning work is required.

In addition, as shown in FIG. 7, the problem data 32 includes data representing the number of employees who can implement the individual work required in each first period within the second period. The number of persons is set for each combination of the product and the individual work. The example of FIG. 7 represents that, on April 1, for the product A, one employee who can implement the thawing work is required, one employee who can implement the culturing work is required, and three employees who can implement the freezing work are required. In addition, the example of FIG. 7 represents that two employees who can implement the recovering work are required for the product B on April 1.

In addition, as shown in a^{PIC} described above, the number of persons in charge required for each product is also set in each first period within the second period. That is, the number of employees required in the first period is set for each position of the employee (a person in charge or a person not in charge in the present embodiment). The number of persons in FIGS. 6 and 7 represents the number of employees who are persons not in charge.

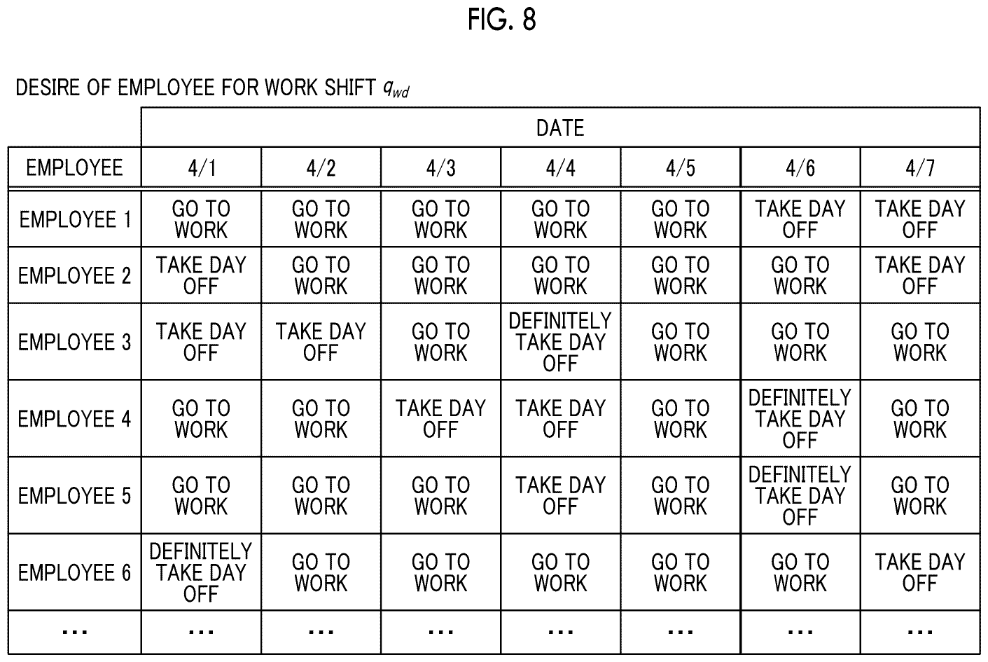

In addition, as shown in FIG. 8, the problem data 32 includes data representing the desire of the work shift of the employee of the first organization in each first period within the second period. In the present embodiment, the desire of the employee for the work shift is represented by a degree of possibility of attendance of the employee in the first period. In the present embodiment, the desire of the employee for the work shift is represented by three stages of “desire to go to work”, “desire to take day off”, and “desire to definitely take day off”. The example of FIG. 8 represents that, on April 1, the employees 1, 4, and 5 desire to go to work, the employees 2 and 3 desire to take a day off, and the employee 6 desires to definitely take a day off. In the desire of the employee for the work shift, “desire to go to work” may be divided into “desire to work at a business office” and “desire to work at home”. In addition, the desire of the employee for the work shift may be represented by two stages, or may be represented by four stages or more.

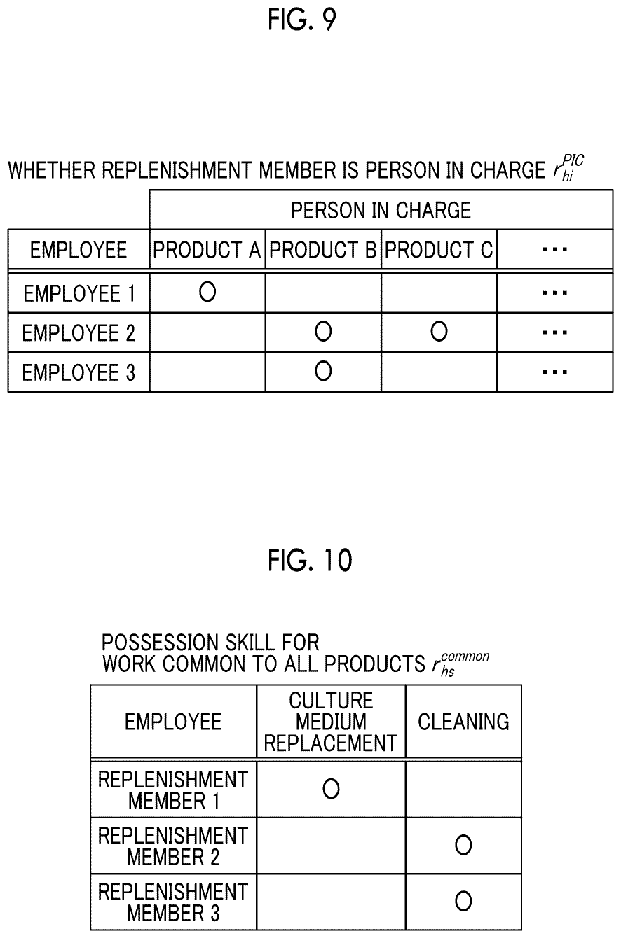

In addition, as shown in FIG. 9, the problem data 32 includes data representing whether the employee (that is, replenishment member) of the second organization is a person in charge of each product. In the example of FIG. 9, each replenishment member is assigned a position of a person in charge for a product of a column described with a circle mark, and is assigned a position of a person not in charge for the product of a blank column. The example of FIG. 9 represents that the replenishment member 1 is a person in charge for the product A and is a person not in charge for the product B and the product C.

In addition, as shown in FIG. 10, the problem data 32 includes data representing a possession skill indicating that the replenishment member can implement the common work. In the example of FIG. 10, each replenishment member can implement the common work of a column described with a circle mark, and cannot implement the common work of a blank column. That is, the possession skill for the common work is allocated to each of a plurality of the replenishment members. The example of FIG. 10 represents that the replenishment member 1 can implement the culture medium replacement and cannot implement the cleaning work on all the products.

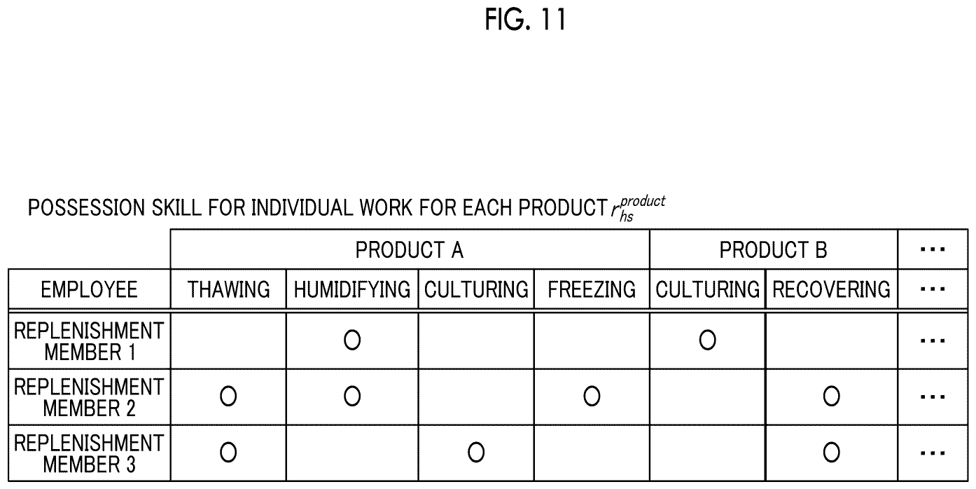

In addition, as shown in FIG. 11, the problem data 32 includes data representing a possession skill indicating that the replenishment member can implement the individual work. In the example of FIG. 11, the replenishment member can implement the individual work of a column described with a circle mark, and cannot implement the individual work of a blank column. That is, for each of the plurality of products, the possession skill for the individual work is assigned to each of the plurality of replenishment members. The example of FIG. 11 represents that the replenishment member 1 can implement the humidifying work and cannot implement each work of the thawing, the culturing, and the freezing on the product A. In addition, the example of FIG. 11 represents that the employee 1 can implement the culturing work and cannot implement the recovering work on the product B.

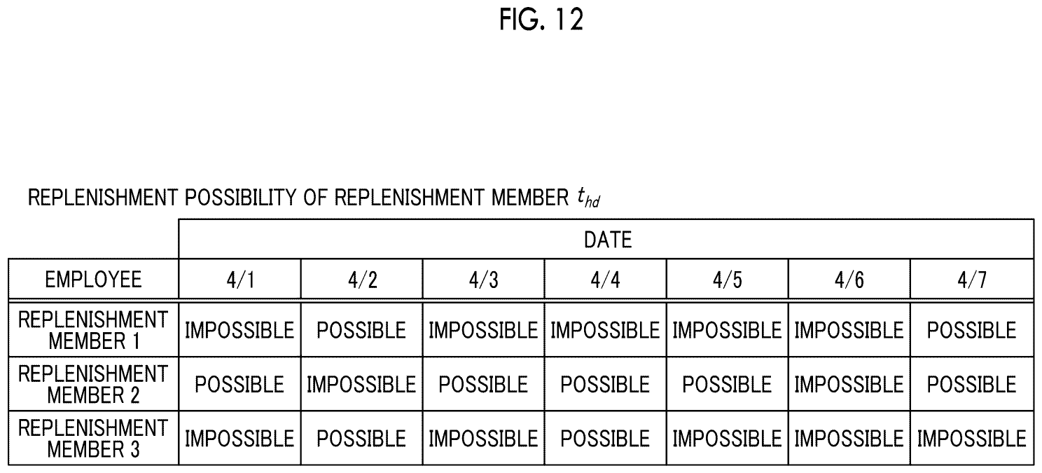

In addition, as shown in FIG. 12, the problem data 32 includes data representing replenishment possibility of the replenishment member in each first period within the second period. The example of FIG. 12 represents that the replenishment with the replenishment member 2 is possible and the replenishment with the replenishment members 1 and 3 is not possible on April 1.

In addition, the problem data 32 includes a decision variable, a constraint condition, and an objective function in order to formulate the shift creation problem as a 0-1 integer programming problem. The decision variable is defined by x_{wd} shown below.
x_{wd}∈{0,1}, w∈W, d∈D: whether to assign attendance to employee w on date d (0: rest, 1: attendance)

The constraint condition is a constraint condition based on the possession skill assigned to each of the plurality of employees and the number of employees required in the predetermined first period, and is a constraint condition regarding the work shift of the employee. The constraint conditions according to the present embodiment are represented by Expressions (1) to (7).

Expression (1) represents a condition that the total number of persons who go to work on each day is equal to or more than the required number of persons who go to work. Expression (2) represents a condition that the number of persons in charge who go to work is the required number (one person in the present embodiment) or more in each combination of each day and each product. Expression (3) represents a condition that, on each day, the number of employees who are assigned the possession skill for each work common to all the products and who go to work is the required number or more. Expression (4) represents a condition that, on each day, the number of employees who are assigned the possession skill for the individual work of each product and who go to work is the required number or more. Expression (5) represents a condition that the number of days off of each employee within a designated period (for example, one week) is equal to or more than the required number of holidays. Expression (6) represents a condition that the number of consecutive days of attendance of each employee is within five days. Expression (7) represents a condition that a day off is allocated in a case where the desire for the work shift is a day to “definitely take a day off”.

$${\sum }_{w} {x}_{wd} \geq {a}_{d} , ∀ d ∈ D \qquad ( 1 )$$

$${\sum }_{w} {p}_{wi}^{PIC} {x}_{wd} \geq {a}^{PIC} , ∀ d ∈ D , ∀ i ∈ I \qquad ( 2 )$$

$${\sum }_{w} {p}_{ws}^{common} {x}_{wd} \geq {a}_{ds}^{common} , ∀ d ∈ D , ∀ s ∈ {S}^{common} \qquad ( 3 )$$

$${\sum }_{w} {p}_{ws}^{product} {x}_{wd} \geq {a}_{ds}^{product} , ∀ d ∈ D , ∀ i ∈ I , ∀ s ∈ {S}_{i}^{product} \qquad ( 4 )$$

$${\sum }_{d} ( 1 - {x}_{wd} ) \geq c , ∀ w ∈ W \qquad ( 5 )$$

$${\sum }_{i = 0}^{5} {x}_{w , d + i} \leq e , ∀ w ∈ W , ∀ d ∈ D \qquad ( 6 )$$

$${x}_{wd} = 0 , ∀ ( w , d ) ∈ \{ ( w , d ) \vert w ∈ W , d ∈ D , {q}_{wd} = 10 \} \qquad ( 7 )$$

The objective function is related to the desire of the employee for the work shift, and is a function that satisfies the desire of the employee as much as possible. In the present embodiment, the objective function is a function whose output value is smaller as it matches the desire of the employee. The objective function is represented by Expression (8).

$$min \{ - {\sum }_{wd} {q}_{wd} {x}_{wd} \} \qquad ( 8 )$$

The information processing apparatus 10 has a function of solving the shift creation problem formulated by the above-described problem data 32.

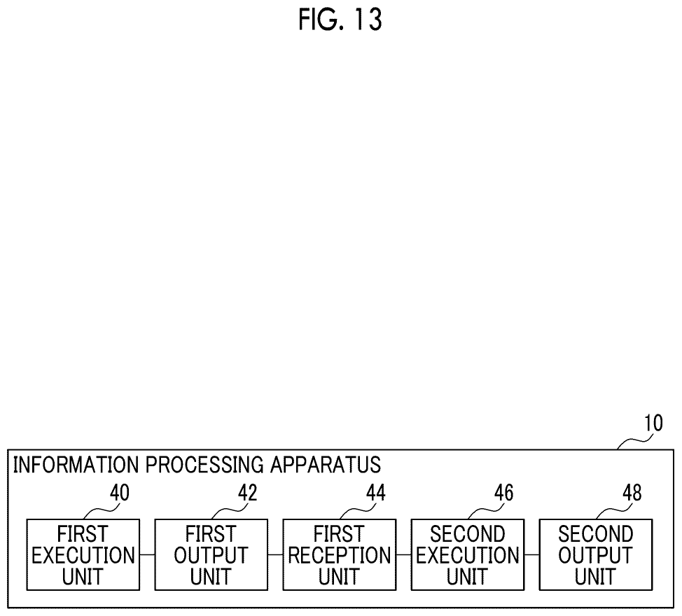

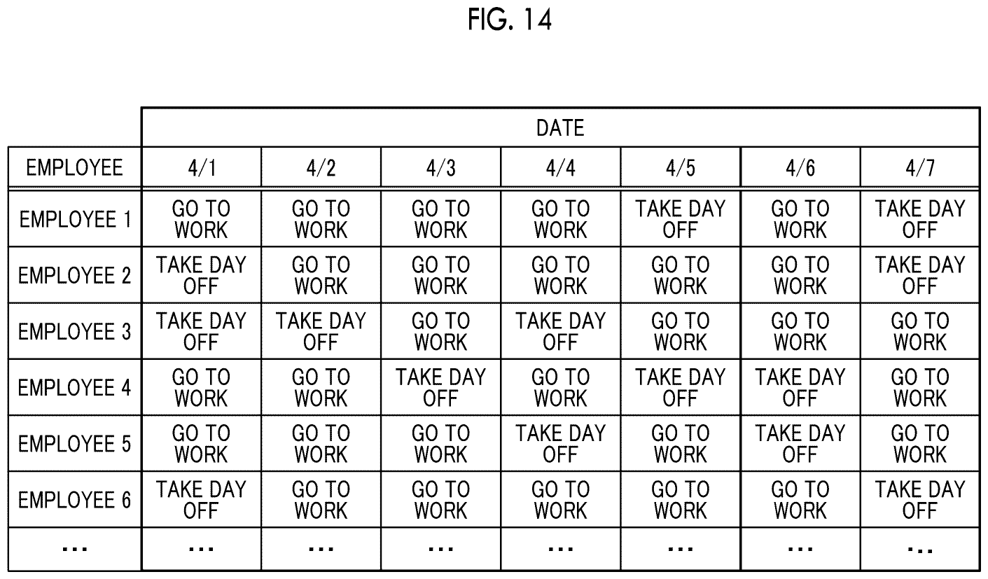

Next, a functional configuration of the information processing apparatus 10 according to the present embodiment will be described with reference to FIG. 13. As shown in FIG. 13, the information processing apparatus 10 includes a first execution unit 40, a first output unit 42, a first reception unit 44, a second execution unit 46, and a second output unit 48. The CPU 20 executes the information processing program 30 to function as the first execution unit 40, the first output unit 42, the first reception unit 44, the second execution unit 46, and the second output unit 48.

The first execution unit 40 refers to the problem data 32 and executes a process of generating a work shift table in which the constraint conditions represented by Expression (1) to Expression (7) are satisfied and the output value of the objective function represented by Expression (8) is minimized (hereinafter, referred to as a “first process”). In this process, for example, a known algorithm such as a branch and bound method, a local search method, a taboo search, a simulated annealing, a quantum annealing, a genetic algorithm, and a swarm intelligence (for example, particle swarm optimization and ant colony optimization) is used.

In a case where a feasible solution is obtained as a result of the solution processing through the first process, the first output unit 42 outputs (that is, stores) the work shift table obtained by the first process to the storage unit 22, and outputs (that is, displays) a message indicating that the feasible solution exists to the display 23. The first output unit 42 may output the existence of the feasible solution by outputting the work shift table obtained by the first process to the display 23.

FIG. 14 shows an example of the work shift table obtained by the first process. As shown in FIG. 14, the work shift table is data representing whether the employee of the first organization goes to work or takes a day off in each first period within the second period. The example of FIG. 14 represents that the employees 1, 4, and 5 go to work and the employees 2, 3, and 6 take a day off on April 1. In the work shift table, for a portion changed from the desire of the employee, a highlighting process such as a process of filling the portion with a preset color or a process of making the portion bolder than an unchanged portion may be performed.

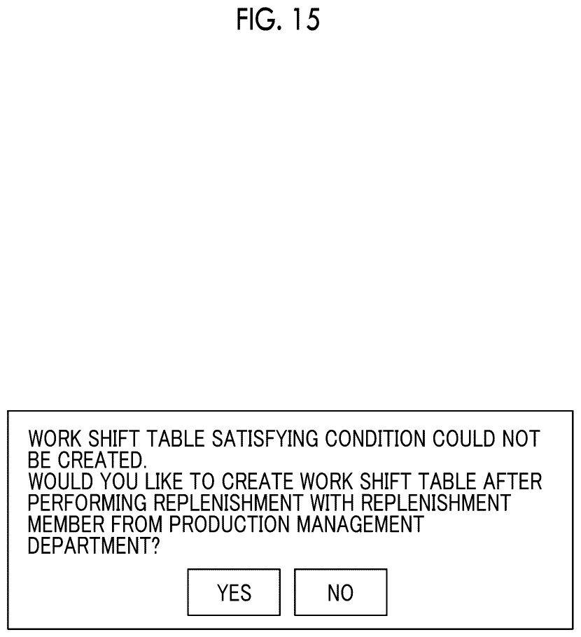

In a case where the feasible solution does not exist in the first process, the first output unit 42 outputs a message indicating that the feasible solution does not exist to the display 23. In this case, the first output unit 42 also outputs a message of inquiring of the user as to whether or not to create the work shift table after performing the replenishment with the replenishment member from the second organization, to the display 23. FIG. 15 shows an example of a screen displayed on the display 23 in a case where the feasible solution does not exist in the first process. As shown in FIG. 15, in this case, a message indicating that the work shift table could not be created is displayed on the display 23 as a message indicating that the feasible solution does not exist. In addition, in this case, the display 23 also displays a message of inquiring of the user as to whether to create the work shift table after replenishing the replenishment member from the second organization. In addition, in this case, as an example of a button for the user to answer, a YES button and a NO button are also displayed on the display 23. In a case where the user creates the work shift table after performing the replenishment with the replenishment member from the second organization, the YES button is designated, and in a case where the replenishment with the replenishment member from the second organization is not performed, the NO button is designated.

The first reception unit 44 receives the designation by the user as to whether or not to create the work shift table after performing the replacement with the replenishment member from the second organization.

In a case where the first reception unit 44 receives the designation to create the work shift table after performing the replenishment with the replenishment member from the second organization, the second execution unit 46 executes a process of generating a work shift table in which an output value of the objective function regarding the number of employees to be replenished from the second organization is minimized (hereinafter, referred to as a “second process”). In addition, in the second process, the second execution unit 46 further generates a work shift table in which an output value of the objective function regarding the insufficient number of employees in the first period is minimized.

Specifically, the second execution unit 46 adds four decision variables regarding the replenishment member and the insufficient number of employees shown below.
y_{hd}∈{0,1}, h∈H, d∈D: whether to perform replenishment with replenishment member h on date d (0: not perform replenishment, 1: perform replenishment
z_{di}^{common}, d∈D, i∈I: the insufficient number for the required number of persons in charge of product i on date d
z_{ds}^{common}, d∈D, s∈S^{common}: the insufficient number for the required number of employees who possess skill for work s common to all products on date d
z_{ds}^{product}, d∈D, i∈I, s∈Sᵢ^{product}: the insufficient number for the required number of employees who possess skill for work s of product i on date d

In addition, the second execution unit 46 adds conditions regarding the number of replenishment members and the insufficient number of employees to the constraint conditions represented by Expression (2) to Expression (4) in the first process, to change the constraint conditions represented by Expression (2) to Expression (4) to constraint conditions represented by Expression (2a) to Expression (4a). Expression (2a) represents a condition that, in each combination of each day and each product, the sum of the number of persons in charge who go to work and the number of employees who are assigned the possession skill, and the insufficient number of employees is the required number or more. Expression (3a) represents a condition that, on each day, the sum of the number of employees who are assigned the possession skill for each work common to all the products and who go to work, the number of replenishment members who go to work, and the insufficient number of employees is the required number or more. Expression (4a) represents a condition that, on each day, the sum of the number of employees who are assigned the possession skill for the individual work of each product and who go to work, the number of replenishment members who go to work, and the insufficient number of employees is the required number or more. The second execution unit 46 may change the constraint condition represented by Expression (1) as necessary. In addition, the second execution unit 46 adds a constraint condition regarding the replenishment possibility of the replenishment member, which is represented by Expression (9). Expression (9) represents a condition that the replenishment is not performed in a case where the replenishment with the replenishment member is not possible.

$${\sum }_{w} {p}_{wi}^{PIC} {x}_{wd} + {\sum }_{h} {r}_{hi}^{PIC} {y}_{hd} + {z}_{di}^{PIC} \geq {a}^{PIC} , ∀ d ∈ D , ∀ i ∈ I \qquad ( 2 a )$$

$${\sum }_{w} {p}_{ws}^{common} {x}_{wd} + {\sum }_{h} {r}_{hs}^{common} {y}_{hd} + {z}_{ds}^{common} \geq {a}_{ds}^{common} , \qquad ( 3 a )$$

$$∀ d ∈ D , ∀ s ∈ {S}^{common}$$

$${\sum }_{w} {p}_{ws}^{product} {x}_{wd} + {\sum }_{h} {r}_{hs}^{product} {y}_{hd} + {z}_{ds}^{product} \geq {a}_{ds}^{product} , \qquad ( 4 a )$$

$$∀ d ∈ D , ∀ i ∈ I , ∀ s ∈ {S}_{i}^{product}$$

$${y}_{hd} = 0 , ∀ ( h , d ) ∈ \{ ( h , d ) \vert h ∈ H , d ∈ D , {t}_{hd} = 0 \} \qquad ( 9 )$$

In addition, the second execution unit 46 adds the objective function regarding the number of replenishment members and the objective function regarding the insufficient number of employees. The objective function regarding the number of replenishment members is represented by Expression (10). The objective function regarding the insufficient number of employees is represented by Expressions (11) to (13). Expression (10) represents that the number of the replenishment members is minimized. Expression (11) represents that the insufficient number of persons in charge is minimized. Expression (12) represents that the insufficient number of employees who are assigned the possession skill for the work common to all the products is minimized. Expression (13) represents that the insufficient number of employees who are assigned the possession skill for the individual work of each product is allocated is minimized;

$$min \{ {\sum }_{h , d} {y}_{hd} \} \qquad ( 10 )$$

$$min \{ {\sum }_{d , i} {z}_{di}^{PIC} \} \qquad ( 11 )$$

$$min \{ {\sum }_{d , s} {z}_{ds}^{common} \} \qquad ( 12 )$$

$$min \{ {\sum }_{d , s} {z}_{ds}^{product} \} \qquad ( 13 )$$

The second execution unit 46 executes, as the second process, a process of generating a work shift table in which the constraint conditions represented by Expression (1), Expression (2a) to Expression (4a), Expression (5) to Expression (7), and Expression (9) are satisfied and the output values of the objective functions represented by Expression (8) and Expression (10) to Expression (13) are minimized. In this process, for example, a known algorithm such as a branch and bound method, a local search method, a taboo search, a simulated annealing, a quantum annealing, a genetic algorithm, and a swarm intelligence is used.

In the second process, the second execution unit 46 may give priority to the objective functions represented by Expression (10) to Expression (13) while giving the highest priority to Expression (8). In this case, for example, the second execution unit 46 may lower the priority in the order of Expression (10), Expression (11), Expression (13), and Expression (12). This means that, in a case where the insufficient number of employees is one or more, the second execution unit 46 first performs a process of allocating the replenishment member as the person who goes to work with priority, and in a case where the number of persons who go to work cannot satisfy the required number even after the process is performed, the second execution unit 46 adjusts the number of employees to satisfy the required number by reducing the value of the insufficient number of employees as small as possible.

In a case where a feasible solution is obtained as a result of the solution processing through the second process, the second output unit 48 outputs the work shift table obtained by the second process to the storage unit 22, and outputs a message indicating that the feasible solution exists to the display 23. The second output unit 48 may output the existence of the feasible solution by outputting the work shift table obtained by the second process to the display 23.

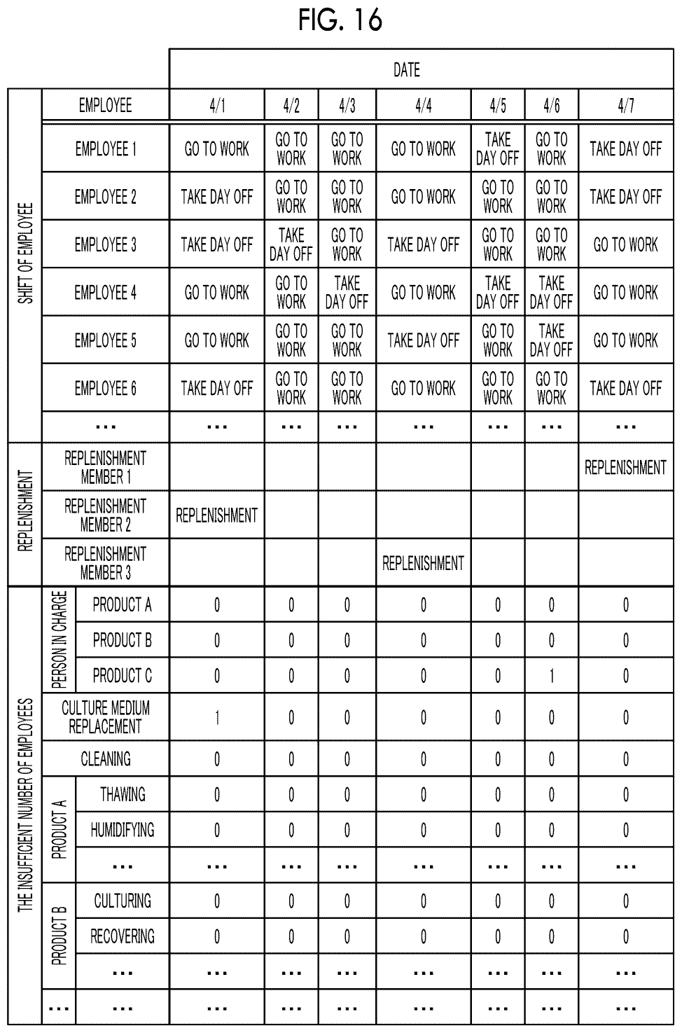

FIG. 16 shows an example of the work shift table obtained by the second process. As shown in FIG. 16, the work shift table obtained by the second process includes data representing whether the employee of the first organization goes to work or takes a day off in each first period within the second period, as with the work shift table obtained by the first process (see FIG. 14). In addition, the work shift table obtained by the second process further includes data representing whether or not the replenishment with the replenishment member is performed in each first period within the second period. The example of FIG. 16 represents that replenishment with the replenishment member 2 is performed on April 1, replenishment with the replenishment member 3 is performed on April 4, and replenishment with the replenishment member 1 is performed on April 7.

In addition, the work shift table obtained by the second process further includes the insufficient number of employees in each first period within the second period. The insufficient number of employees includes the insufficient number of persons in charge for each product, the insufficient number of employees who can implement the common work, and the insufficient number of employees who can implement the individual work of the product for each combination of the product and the individual work. The example of FIG. 16 represents that the insufficient number of employees who can implement the culture medium replacement, which is the common work, is one on April 1. In addition, the example of FIG. 16 represents that the insufficient number of persons in charge of the product C is one on April 6.

A portion where the replenishment with the replenishment member is required and a portion where the insufficient number of employees is one or more in the work shift table obtained by the second process correspond to the insufficient number of employees of the first organization in that day (that is, the first period). In addition, the insufficient number of employees of the first organization corresponds to cause information representing a cause of the absence of the feasible solution by the first process. Accordingly, the user can understand causes such as on which day and for which work the first employee is not enough, and on which day and in which position the first employee is not enough by viewing the work shift table shown in FIG. 16.

In addition, in a case where the feasible solution does not exist in the second process, the second output unit 48 outputs a message indicating that the feasible solution does not exist to the display 23.

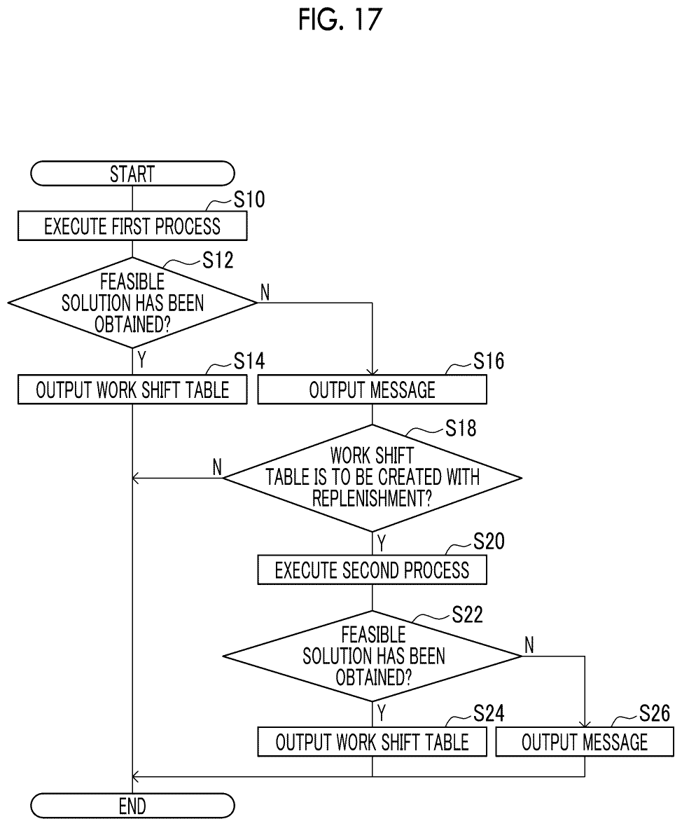

Next, actions of the information processing apparatus 10 according to the present embodiment will be described with reference to FIG. 17. The CPU 20 executes the information processing program 30 to execute work shift table generation processing shown in FIG. 17. The work shift table generation processing shown in FIG. 17 is executed, for example, in a case where an instruction to start the execution is input by the user via the input device 24.

In step S10 of FIG. 17, as described above, the first execution unit 40 refers to the problem data 32 and executes the first process. In step S12, the first output unit 42 determines whether or not the feasible solution has been obtained as a result of the solution processing through the first process in step S10. In a case where an affirmative determination is made in the determination, the process proceeds to step S14.

In step S14, as described above, the first output unit 42 outputs the work shift table obtained by the first process in step S10 to the storage unit 22, and outputs a message indicating that the feasible solution exists to the display 23. In a case where the process of step S14 ends, the work shift table generation processing ends.

In a case where a negative determination is made in the determination of step S12, the process proceeds to step S16. In step S16, the first output unit 42 outputs a message indicating that the feasible solution does not exist to the display 23. In this case, the first output unit 42 also outputs a message of inquiring of the user as to whether or not to create the work shift table after performing the replenishment with the replenishment member from the second organization, to the display 23.

In step S18, the first reception unit 44 receives the designation by the user as to whether or not to create the work shift table after performing the replacement with the replenishment member from the second organization. Then, the first reception unit 44 determines whether or not to create the work shift table after performing the replacement with the replenishment member from the second organization. In a case in which the user designates the NO button in the screen (see FIG. 15) displayed on the display 23 by the process of step S16, a negative determination is made in the determination in step S18, and the work shift table generation processing ends. In a case in which the user designates the YES button in the screen displayed on the display 23 by the process of step S16, an affirmative determination is made in the determination in step S18, and the proceeds to step S20.

In step S20, the second execution unit 46 executes the second process as described above. In step S22, the second output unit 48 determines whether or not the feasible solution has been obtained as a result of the solution processing through the second process in step S20. In a case where an affirmative determination is made in the determination, the process proceeds to step S24. In step S24, the work shift table obtained by the second process in step S20 is output to the storage unit 22, and a message indicating that the feasible solution exists is output to the display 23. In a case where the process of step S24 ends, the work shift table generation processing ends.

In a case where a negative determination is made in the determination of step S22, the process proceeds to step S26. In step S26, the second output unit 48 outputs a message indicating that the feasible solution does not exist to the display 23. In a case where the process of step S26 ends, the work shift table generation processing ends.

As described above, according to the present embodiment, it is possible to generate the detailed work shift table.

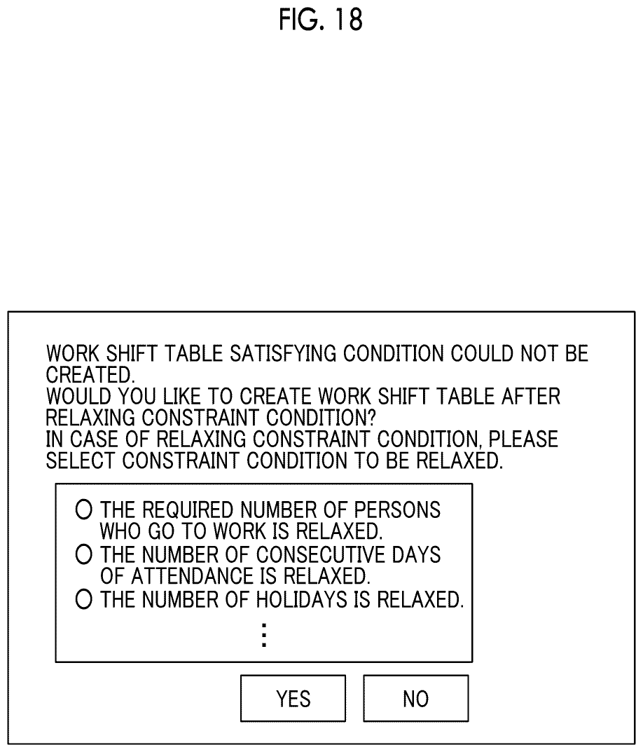

In the above-described embodiment, in a case where the feasible solution does not exist in the second process, the second output unit 48 may output a message of inquiring of the user as to whether or not to create the work shift table after relaxing the constraint condition, to the display 23. FIG. 18 shows an example of a screen displayed on the display 23 in this case. As shown in FIG. 18, in this case, a message indicating that the work shift table could not be created is displayed on the display 23 as a message indicating that the feasible solution does not exist. In addition, in this case, the display 23 also displays a message of inquiring as to whether to create the work shift table after relaxing the constraint condition. In addition, in this case, as an example of a button for the user to answer, a YES button and a NO button are also displayed on the display 23. In addition, in this case, a list of the relaxable constraint conditions and a radio button for selection by checking the constraint condition to be relaxed by the user are also displayed.

In a case where the user creates the work shift table after relaxing the constraint condition, the user checks the radio button corresponding to the constraint condition to be relaxed and then designates the YES button. In this case, the second execution unit 46 generates the work shift table by executing the second process again after relaxing the constraint condition selected by the user.

For example, in a case where the user selects to relax the number of holidays, the second execution unit 46 reduces the value of the variable c on the right side of Expression (5) by 1, and then executes the second process again. In a case where the user relaxes the constraint condition, the value of the constraint condition after the relaxation may be designated. In addition, the user may select a plurality of constraint conditions as the constraint condition to be relaxed. In addition, as the constraint condition to be relaxed, the user may delete the constraint condition. That is, the relaxation of the constraint condition includes a case where the constraint condition is deleted.

In addition, even in a case where there is a portion where the insufficient number of employees is one or more in the work shift table obtained by the second process, the second output unit 48 may similarly output a message of inquiring of the user as to whether or not to create the work shift table after relaxing the constraint condition, to the display 23. In this case as well, in a case where the user creates the work shift table after relaxing the constraint condition, the user checks the radio button corresponding to the constraint condition to be relaxed and then designates the YES button. In this case, the second execution unit 46 generates the work shift table by executing the second process again after relaxing the constraint condition selected by the user.

In addition, in the above-described embodiment, the second execution unit 46 may generate the work shift table without considering the replenishment member. In this case, it is possible to obtain the insufficient number of employees in a state in which the employees are not replenished from the second organization.

In addition, in the above-described embodiment, a case has been described in which the first execution unit 40 generates the work shift table of the employees of the first organization in each first period within the second period, but the present disclosure is not limited to this. For example, the first execution unit 40 may generate the work shift table for each first period. Specifically, the first execution unit 40 may generate the work shift table for each day.

In addition, in the above-described embodiment, a case has been described in which the second period is one week, but the present disclosure is not limited to this. For example, the second period may be a period shorter than one week or a period longer than one week.

In addition, in the embodiment described above, a case where the first period is 1 day has been described, but the present disclosure is not limited to this. For example, the first period may be a period (for example, 8 hours or 12 hours) shorter than one day or a period longer than one day.

In addition, in the above-described embodiment, for example, as a hardware structure of a processing unit that executes various kinds of processing, such as the first execution unit 40, the first output unit 42, the first reception unit 44, the second execution unit 46, and the second output unit 48, the following various processors can be used. The various processors include, as described above, in addition to a CPU, which is a general-purpose processor that functions as various processing units by executing software (program), a programmable logic device (PLD) that is a processor of which a circuit configuration may be changed after manufacture, such as a field programmable gate array (FPGA), and a dedicated electrical circuit which is a processor having a circuit configuration specially designed to execute specific processing, such as an application specific integrated circuit (ASIC).

One processing unit may be configured of one of the various processors, or may be configured of a combination of the same or different kinds of two or more processors (for example, a combination of a plurality of FPGAs or a combination of the CPU and the FPGA). In addition, a plurality of processing units may be configured of one processor.

As an example in which a plurality of processing units are configured of one processor, first, as typified by a computer such as a client or a server, there is an aspect in which one processor is configured of a combination of one or more CPUs and software, and this processor functions as a plurality of processing units. Second, as typified by a system on chip (SoC) or the like, there is an aspect in which a processor that implements functions of the entire system including the plurality of processing units via one integrated circuit (IC) chip is used. As described above, various processing units are configured by using one or more of the various processors as a hardware structure.

Further, as the hardware structure of the various processors, more specifically, an electric circuit (circuitry) in which circuit elements such as semiconductor elements are combined may be used.

In addition, in the embodiment described above, an aspect has been described in which the information processing program 30 is stored (installed) in the storage unit 22 in advance, but the present disclosure is not limited to this. The information processing program 30 may be provided in a form of being recorded in a recording medium such as a compact disc read only memory (CD-ROM), a digital versatile disc read only memory (DVD-ROM), and a universal serial bus (USB) memory. In addition, the information processing program 30 may be downloaded from an external device via a network.

The disclosure of JP2022-004644 filed on Jan. 14, 2022 is incorporated herein by reference in its entirety. In addition, all literatures, patent applications, and technical standards described herein are incorporated by reference to the same extent as if the individual literature, patent applications, and technical standards were specifically and individually stated to be incorporated by reference.

What is claimed is:

1. An information processing apparatus, comprising:
at least one processor, wherein the processor:
executes a first process of generating a work shift table in which a constraint condition regarding a work shift of an employee is satisfied, and an output value of an objective function regarding a desire of the employee for the work shift is minimized, the constraint condition being based on a skill or skills assigned to each of a plurality of the employees and representing an ability to implement work on a work target, and the number of employees required in a predetermined period, the plurality of employees being employees belonging to a first organization,
executes a second process of generating a work shift table in which an output value of an objective function regarding the number of employees to be replenished from a second organization different from the first organization is minimized in a case in which a feasible solution does not exist in the first process, and
outputs an insufficient number of employees of the first organization in the predetermined period for each skill as cause information indicating a cause of absence of the feasible solution in the first process.

2. The information processing apparatus according to claim 1, wherein, in the second process, the processor further generates a work shift table in which an output value of an objective function regarding the insufficient number of employees in the period is minimized.

3. The information processing apparatus according to claim 1, wherein, in a case where the feasible solution does not exist in the second process, the processor generates the work shift table after relaxing the constraint condition.

4. The information processing apparatus according to claim 1, wherein, in a case where the insufficient number of employees is one or more, the processor generates the work shift table after relaxing the constraint condition.

5. The information processing apparatus according to claim 1, wherein a skill is assigned to the employee for each of a plurality of the work targets.

6. The information processing apparatus according to claim 1, wherein the number of employees required in the period is set for each position of the employee.

7. The information processing apparatus according to claim 1, wherein the desire of the employee for the work shift is represented by a degree of possibility of attendance by the employee in the period.

8. An information processing method executed by a processor of an information processing apparatus, the method comprising:
executing a first process of generating a work shift table in which a constraint condition regarding a work shift of an employee is satisfied, and an output value of an objective function regarding a desire of the employee for the work shift is minimized, the constraint condition being based on a skill or skills assigned to each of a plurality of the employees and representing an ability to implement work on a work target, and the number of employees required in a predetermined period, the plurality of employees being employees belonging to a first organization;
executing a second process of generating a work shift table in which an output value of an objective function regarding the number of employees to be replenished from a second organization different from the first organization is minimized in a case in which a feasible solution does not exist in the first process; and
outputting an insufficient number of employees of the first organization in the predetermined period for each skill as cause information indicating a cause of absence of the feasible solution in the first process.

9. An information processing program executable by a processor of an information processing apparatus to perform processing comprising:
executing a first process of generating a work shift table in which a constraint condition regarding a work shift of an employee is satisfied, and an output value of an objective function regarding a desire of the employee for the work shift is minimized, the constraint condition being based on a skill or skills assigned to each of a plurality of the employees and representing an ability to implement work on a work target, and the number of employees required in a predetermined period, the plurality of employees being employees belonging to a first organization;
executing a second process of generating a work shift table in which an output value of an objective function regarding the number of employees to be replenished from a second organization different from the first organization is minimized in a case in which a feasible solution does not exist in the first process; and
outputting an insufficient number of employees of the first organization in the predetermined period for each skill as cause information indicating a cause of absence of the feasible solution in the first process.

10. The information processing program of claim 9, wherein the information processing program is stored on a non-transitory computer-readable storage medium.
